(19) United States
(12) Patent Application Publication
(10) Pub. No.: US 2003/0009389 A1
(43) Pub. Date: Jan. 9, 2003

(54) System and method for receiving and shipping tobacco units

(76) Inventor: Tracy G. Purvis, Winterville, NC (US)

Correspondence Address: Christopher C. Campbell, HUNTON & WILLIAMS, 1900 K Street, N.W., Washington, DC, 20006-1109, US

(21) Appl. No.: 09/899,110

(22) Filed: Jul. 6, 2001

(51) Int. Cl. G06F 17/60

(52) U.S. Cl. 705/26

(57) ABSTRACT

The systems and methods of the invention provide for enhanced communication and exchange of information, relating to tobacco transactions, between a grower, an agent and a controlling entity, for example. The controlling entity is allowed to closely monitor the activities of the agent and the grower, or multiple agents and multiple growers. An identification tag may be placed upon the tobacco unit when the unit is initially at the grower. This identification tag may then go with the tobacco unit through a variety of transactions. The ease and efficiency of the transactions are benefited by utilizing scanning techniques. Various other processing and tracking techniques are used in the systems and methods of the invention.

### FIELD OF THE INVENTION

The system and method of the invention relate to receiving and shipping units of tobacco by an agent under the control of an entity, and more particularly, to a system and method for monitoring the receipt of tobacco by the agent, storage of the tobacco in inventory by the agent, and thereafter, shipment of the tobacco from the agent to the entity.

### BACKGROUND OF THE INVENTION

Tobacco is a plant that has been cultivated and sold for hundreds of years. The leaves of a tobacco plant may be utilized for a variety of purposes. For example, the leaves of the tobacco plant may be dried and thereafter processed in some manner suitable for the desired end product. The tobacco plant may be processed for use in cigarettes or smoking of pipes, for example.

The growing, cultivation and ultimate sale to an end customer involves a wide variety of transactions. Commonly, the process starts with a grower growing the tobacco on a farm. One particular grower may control a number of farms. Alternatively, portions of one farm may be respectively controlled by different growers. Once the tobacco is cultivated, the tobacco is commonly then prepared for shipment. Typically, the tobacco may be prepared for shipment in the form of bales. The tobacco may be shipped utilizing any suitable technique such as by land, air, or sea. The tobacco may be shipped from the grower to an agent.

The agent receives the tobacco and checks the tobacco based on a variety of parameters as desired. Commonly, the agent checks the received tobacco for weight and quality, i.e., grade, for example. However, it should be appreciated that various other attributes of the received tobacco may be checked. Once the agent receives and checks the tobacco, the agent may then place the tobacco into a warehouse or other storage area. Thereafter, the agent may then ship the tobacco on to a further entity. Illustratively, this further entity may be characterized as a “controlling entity.” The controlling entity may have a number of agents from which the controlling entity receives shipments of tobacco. Once the tobacco is received by the controlling entity, the controlling entity may then continue the transaction of the tobacco in any desired manner such as further selling the tobacco or processing the tobacco, for example.

However, it should be appreciated that conventional techniques fall short of effectively monitoring the transaction as described above. Additionally, there are various other aspects of the above transaction that would also be useful to monitor. The monitoring of the transaction becomes especially complex when dealing with multiple growers, multiple farms and multiple agents working with one controlling entity. Accordingly, the system and method of the invention address these and other shortcomings of conventional processes.

### SUMMARY OF THE INVENTION

The systems and methods of the invention provide for enhanced communication and exchange of information, relating to tobacco transactions, between a grower, an agent and a controlling entity, for example. The controlling entity is allowed to closely monitor the activities of the agent and the grower, or multiple agents and multiple growers. An identification tag may be placed upon the tobacco unit when the unit is initially at the grower. This identification tag may then go with the tobacco unit through a variety of transactions. The ease and efficiency of the transactions are benefited by utilizing scanning techniques. Various other processing and tracking techniques are used in the systems and methods of the invention.

### BRIEF DESCRIPTION OF THE DRAWINGS

The present invention can be more fully understood by reading the following detailed description of the presently preferred embodiments together with the accompanying drawings, in which like reference indicators are used to designate like elements and in which:

FIG. 1 is a block diagram showing a transaction system, which includes a grower, agent and entity in accordance with one embodiment of the system and method of the invention;

FIG. 2 is a flow chart showing the transaction process in accordance with one embodiment of the system and method of the invention;

FIG. 3 is a flow chart showing the tobacco is prepared by grower step of FIG. 2 in further detail in accordance with one embodiment of the system and method of the invention;

FIG. 4 is a flow chart showing the baled tobacco is received and inventoried step of FIG. 2 in further detail in accordance with one embodiment of the system and method of the invention;

FIG. 5 is a flow chart showing the perform scanner operator operations step of FIG. 2 in further detail in accordance with one embodiment of the system and method of the invention;

FIG. 6 is a flow chart showing the perform operations to document and report receipt of units step of FIG. 4 in further detail in accordance with one embodiment of the system and method of the invention;

FIG. 7 is a flow chart showing the load request is received and processed step of FIG. 2 in further detail in accordance with one embodiment of the system and method of the invention; and

FIG. 8 is an illustrative user interface showing aspects of operations of a receiving station in accordance with one embodiment of the system and method of the invention.

### DETAILED DESCRIPTION OF THE INVENTION

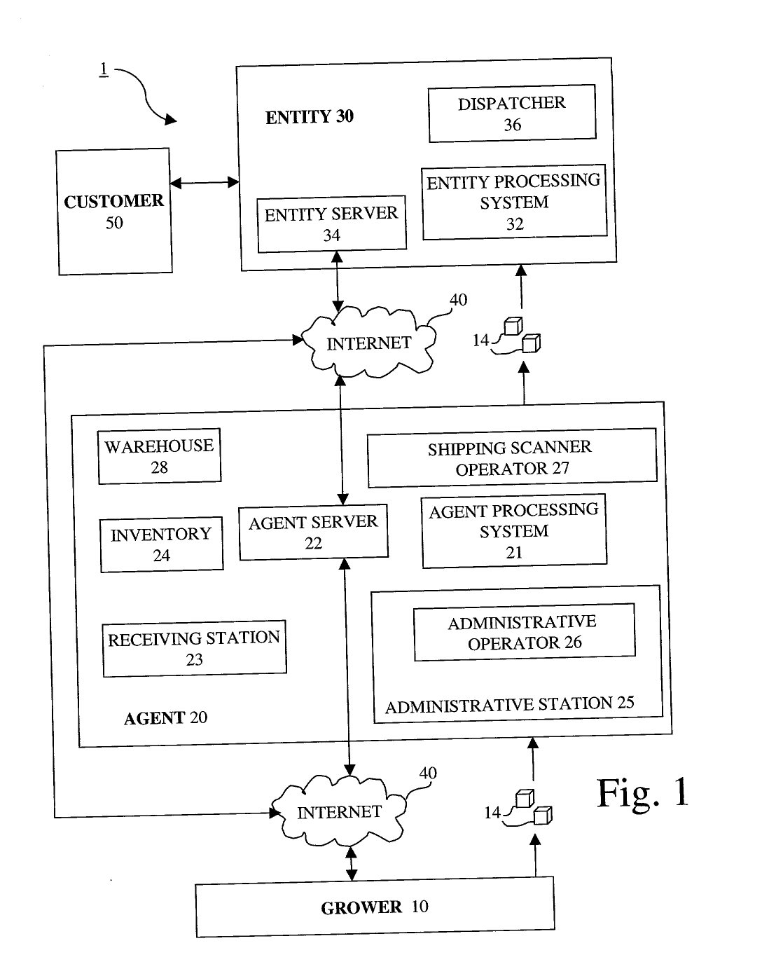

Hereinafter, the system and method of the invention are described with reference to FIG. 1. FIG. 1 is a block diagram showing a transaction system 1. The transaction system 1 includes a grower 10, an agent 20, and an entity 30. Each of the grower 10, the agent 20 and the entity 30 may be connected utilizing a suitable communications pathway, such as the Internet or a network 40. Accordingly, FIG. 1 shows a pathway utilizing the Internet 40. Additionally, the transaction system 1 includes a customer 50. The customer 50 may be a wide variety of entities including an end-user customer or an intermediate retailer, for example.

The transaction system 1 includes the agent 20 and the entity 30. It should be appreciated that the agent 20 may be any of a wide variety of entities that act as an intermediary between the grower 10 and the entity 30. Further, the entity 30 may be a variety of entities. That is, the entity 30 may be any of a company, organization or any other operating entity that is in the business of monitoring, controlling or receiving tobacco products, for example, and thereafter passing the tobacco products on to a further destination. That is, it should be appreciated that the units of tobacco may or may not physically pass through the entity 30. Rather, the entity 30 may simply control further processing and shipment of the tobacco.

It should further be appreciated that the nature of the grower 10 may widely vary. For example, the grower 10 may be in the form of a grower that controls multiple farms. Alternatively, the grower 10 may actually include multiple growers who together cultivate tobacco on one or multiple farms, for example.

Once cultivated, the grower 10 prepares the tobacco in a form suitable for shipping. In accordance with one illustrative embodiment of the system and method of the invention, the grower prepares the tobacco in the form of bales. However, it should be appreciated that any other unit of tobacco may be utilized as is desired. The grower can then physically ship the tobacco to the agent 20 as shown in FIG. 1. Accordingly, FIG. 1 shows units of tobacco 14 being shipped from the grower 10 to the agent 20.

Hereinafter, further details of the agent 20 will be described. As shown in FIG. 1, the agent 20 includes an agent processing system 21, an agent server 22, a receiving station 23, an inventory 24, an administrative station 25, and administrative operator 26 that interacts with the administrative station, a shipping scanner operator 27, and a warehouse 28. It should be appreciated that such components of the agent 20 may comprise a human person, a location and/or a computer operating system, for example.

The agent server 22 may be in the form of an operating system that allows the agent 20 to communicate over the internet 40. It should be appreciated, the agent server 22 may also take on a wide variety of forms, as is desired.

The agent 20 includes the agent processing system 21 and the administrative station 25. The agent processing system 21, in accordance with this illustrative embodiment, operates in conjunction with the administrative station 25 to perform various processing functions allowing operations of the agent 20. Further details of the operations and processing performed in the agent processing system 21 and the administrative station 25 are described below. The agent processing system 21 and the administrative station 25 are provided with suitable user interfaces which allow human operators to interact with the agent processing system 21 and the administrative station 25. Further, it should be appreciated that each of the components in the agent 21 may be in communication with each other either electronically or otherwise. Accordingly, the agent processing system 21 and the administrative station 25 are in communication with the agent server 22, so as to be able to communicate over the Internet 40.

The agent 20 also includes a receiving station 23. The receiving station 23 may be in the form of a physical room as well as suitable operating systems in that room, which may be in communication with the agent processing system 21, to handle the receipt of units of tobacco 14. Further, the agent 20 includes an inventory 24. The inventory 24 may be in the form of a physical location in which the units of tobacco 14 are stored subsequent to receipt and processing in the receiving station 23. The agent 20 may also include a warehouse 28. For example, the warehouse 28 might be utilized to store units of tobacco on a longer term basis.

The agent 20 also includes a shipping scanner operator 27. The shipping scanner operator 27 is a person and/or an operating system that controls the shipment of the units of tobacco from the agent 20 to the entity 30.

Hereinafter, further details of the entity 30 will be described. The entity 30 includes an entity processing system 32, an entity server 34, and a dispatcher 36. The entity processing system 32 performs a wide variety of processing dealing with operations of the entity 30. Further, the entity processing system 32 includes a variety of user interfaces that allow a human user to interact with the entity processing system 32. The entity processing system 32 is in communication with the entity server 34 so as to communicate with the agent, for example, over the Internet 40. Further, the entity 30 includes the dispatcher 36. The dispatcher 36 may be a human person and/or a processing system that monitors and controls various aspects relating to the logistics pertaining to interaction between the entity 30 and the agent 20. Further details of the dispatcher 36 are described below. It should be appreciated that each of the entity processing system 32, the entity server 34, and the dispatcher 36 are in communication with each other so as to be able to exchange data as is desired.

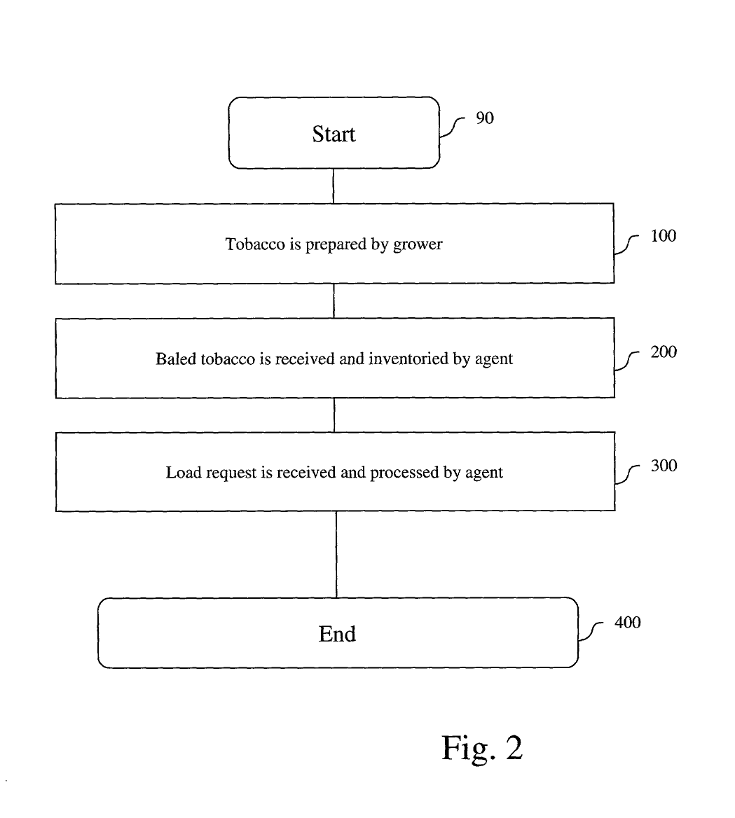

FIG. 2 is a high level flow chart showing a process in accordance with one embodiment of the system and method of the invention. Hereinafter, with further reference to the transaction system 1 as shown in FIG. 1, the process will be described with reference to FIG. 2-FIG. 7.

As shown in FIG. 2, the process starts in step 90. Subsequent to the process starting in step 90, the next step is step 100. In step 100, the tobacco is prepared by the grower. For example, the cultivated tobacco may be processed into units of tobacco such as bales. After step 100, the process passes to step 200. In step 200, the baled tobacco is received from the grower and inventoried by the agent. Then, the process passes to step 300 as shown in FIG. 2. In step 300, a load request, from the entity 30, is received and processed by the agent. After step 300, the process passes to step 400. In step 400, the process ends. Hereinafter, further details of the transaction process shown in FIG. 2 will be described.

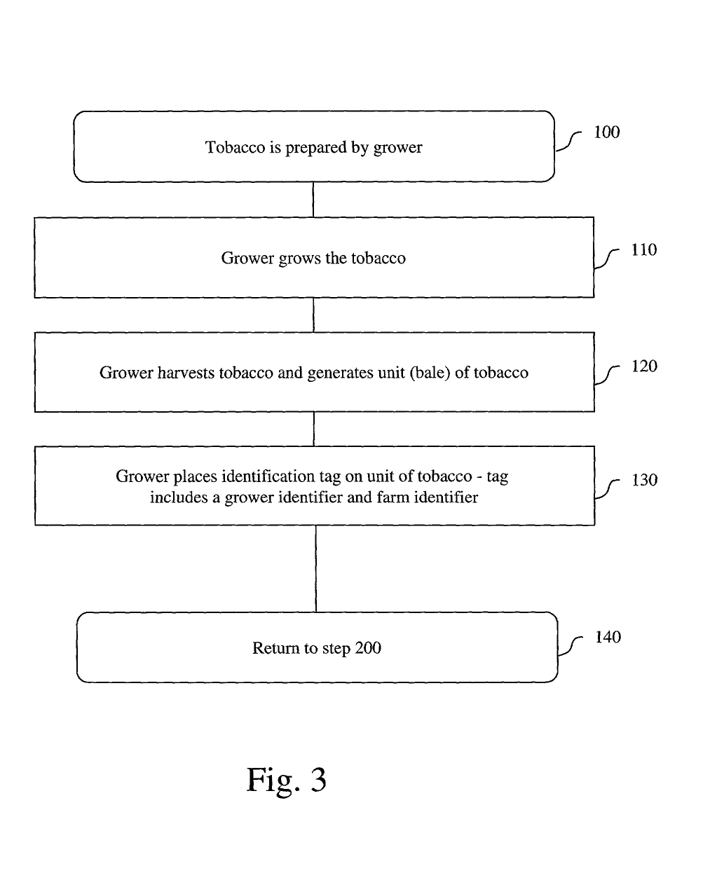

FIG. 3 is a flow chart showing the tobacco is prepared by grower step 100 of FIG. 2. As shown in FIG. 3, the process starts in step 100. Then, the process passes to step 110. In step 110, the grower grows the tobacco. Then, in step 120, the grower harvests the tobacco and generates units, for example bales, of the tobacco. However, it should be appreciated that the system and method of the invention are not limited to transactions utilizing bales of tobacco. Rather, the units of tobacco may take on any suitable form as is desired. For example, the tobacco may be stored in a suitable container. After step 120, the process passes to step 130.

In step 130, the grower places an identification tag on the units of tobacco. The tag includes a grower identifier and a farm identifier in accordance with one embodiment of the methods and systems of the invention. Also, the tag may include an FSA (Farm Service Agency) number, for example. Further aspects of the tag are described below. After step 130, the process passes to step 140. In step 140, the process returns to step 200 as shown in FIG. 2.

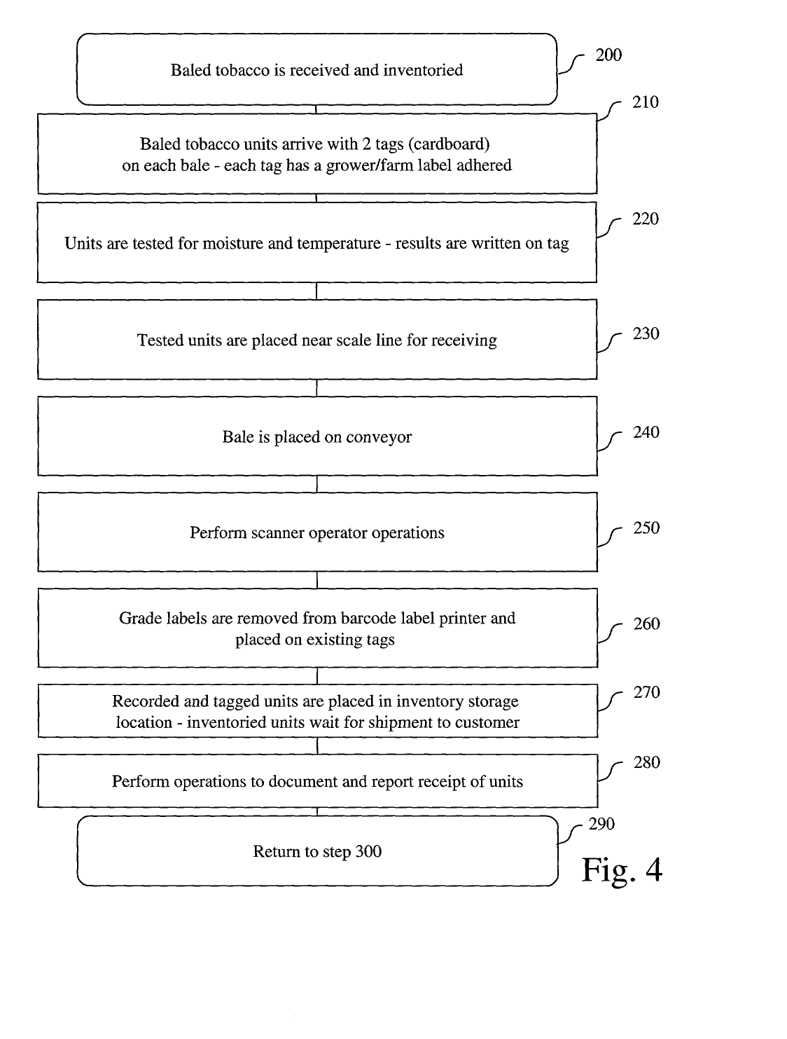

FIG. 4 is a flow chart showing in further detail the baled tobacco is received and inventoried step 200 of FIG. 2. As shown in FIG. 4, the process starts in step 200. Then, the process passes to step 210. In step 210, the baled tobacco units arrive with two (2) tags on each bale. Each tag has a grower/farm label adhered thereto. The tags may be in any suitable form such as in the form of cardboard tags.

Then, the process passes to step 220. In step 220, the units are tested for moisture and temperature. The results of such tests for moisture and temperature are then recorded on the tag. However, it should be appreciated that other tests may be performed in addition to those for moisture and temperature, as is desired. Then, the process passes to step 230. In step 230, the tested units are placed near a scale line for receiving. Then, the bale is placed on a conveyor in step 240, in accordance with this illustrative embodiment of the system and method of the invention. However, it should of course be appreciated that any other mode of transportation may be utilized.

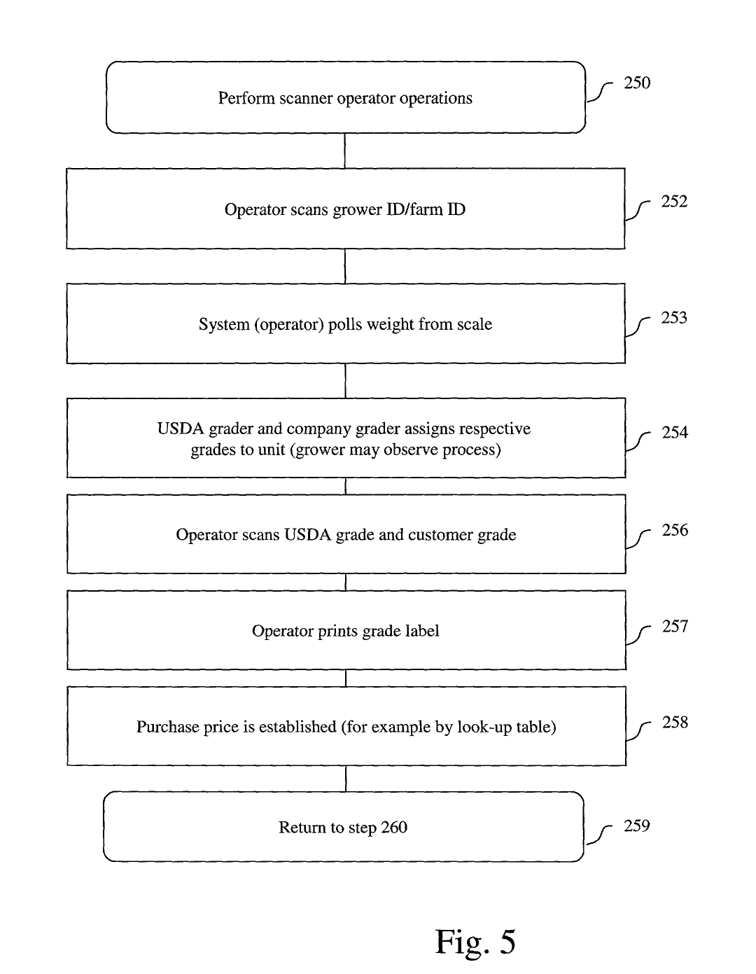

After step 240, the process passes to step 250. In step 250, a scanner operator performs various operations on the bale. Further details of the operations performed by the scanner operator are described with reference to FIG. 5 below. After step 250, the process passes to step 260.

In step 260, the grade labels are removed from a barcode label printer and placed on the existing cardboard tags. That is, the barcode label printer generates labels documenting the input of the scanner operator in step 250, as well as any other information as is desired. After step 260, the process passes to step 270.

In step 270, the recorded and tagged units are placed in an inventory storage location, such as in inventory 24 shown in FIG. 1. Accordingly, the inventoried units are held at the inventoried storage location for shipment to the customer at some subsequent time.

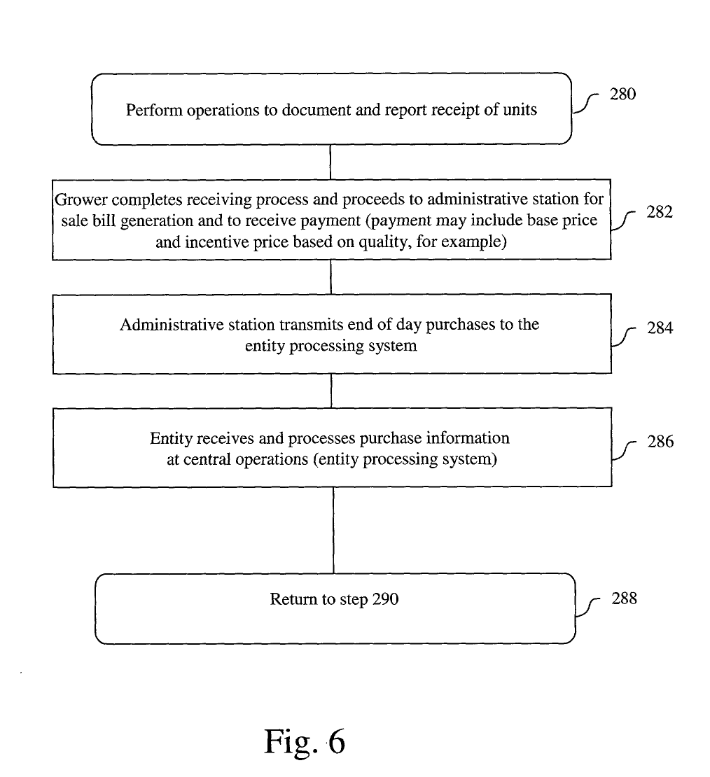

After step 270 as shown in FIG. 4, the process passes to step 280. In step 280, various operations are performed to document and report receipt of the tobacco units from the grower. Further features of step 280 are described below with reference to FIG. 6. After step 280, the process passes to step 290. In step 290, the process returns to step 300, as shown in FIG. 3.

FIG. 5 is a flow chart showing further details of the perform scanner operator operations step 250 of FIG. 4. As shown in FIG. 5, after step 250, the process passes to step 252. In step 252, the operator scans both the grower identification (ID) as well as the farm ID. After step 252, the process passes to step 253. In step 253, the system, or alternatively a human operator, polls the weight of a respective unit of tobacco from the scale. Then, in step 254, a United States Department of Agriculture (USDA) grader and a company grader assigns respective grades to the units of tobacco. It should be appreciated that the grower may observe a portion or all of this process. After step 254, the process passes to step 256. In step 256, the operator scans the USDA grade and the customer grade. Then, in step 257, the operator prints a grade label. These grade labels are later removed from the printer, as described in conjunction with step 260 of FIG. 4 above.

As described in various embodiments herein, the systems and methods of the invention are used in conjunction with oversight by the USDA. However, it should of course be appreciated that any price control grader, or other regulating organization, might be used in conjunction with the systems and methods of the invention.

After step 257, the process passes to step 258. In step 258, the purchase price of the unit of tobacco is established. The purchase price may be computed by the agent processing system 21 utilizing any of the unit parameters described above, as well as any other suitable parameter. Further, it should be appreciated that the purchase price might be based on specifics of the unit of tobacco, as well as other external parameters. For example, the purchase price may be based upon the geographical region in which the agent 20 is located, the current time of year, or the market conditions in other geographical areas, for example. It should be appreciated that since the agent 20 is in communication with the entity 30, this allows a wide variety of such parameters to be taken into account both easily and quickly. For example, the entity 30 may control both agents and growers in substantially different geographical regions. Accordingly, the entity 30 may be able to efficiently calculate the purchase price based on such a wide variety of parameters.

For example, the agent processing system 21 may calculate the purchase price based on the above described parameters utilizing any of a variety of techniques. For example, the agent processing system 21 may calculate the purchase price based on a look-up table. Alternatively, the agent processing system 21 may calculate the purchase price based on a set of equations. It should be appreciated that the agent processing system 21 may communicate directly with the entity processing system 32, if desired, during the calculation of the purchase price. Alternatively, it should be appreciated that the various parameters effecting the purchasing price may be actually output to the entity 30 such that the purchase price is actually computed in the entity processing system 32. Thereafter, the purchase price may then be returned to the agent 20, and specifically the agent processing system 21. This might enhance the ability for the entity 30 to effectively operate while maintaining certain proprietary information, i.e. such as that used in the calculation of the purchase price, from the agent 20.

With further reference to FIG. 5, after step 258, the process passes to step 259. In step 259, the process returns to step 260 as shown in FIG. 4.

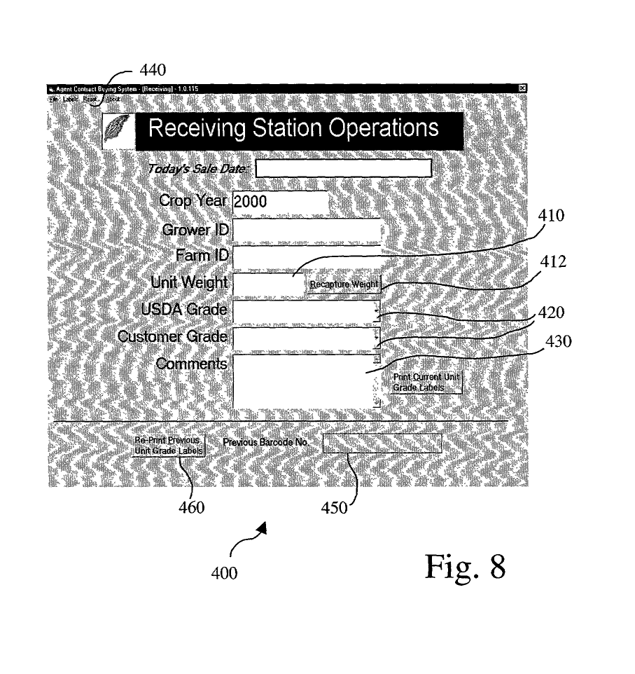

FIG. 8 is an illustrative user interface 400 showing aspects of operations of the receiving station 23 in accordance with one embodiment of the system and method of the invention. As shown in FIG. 8, the user interface 400 may be generated by the agent processing system 21 or another suitable processing system in the agent 20. The user interface 400 provides for entry of information to identify a bale, weigh the bale, and then grade the bale, for example. In accordance with one embodiment of the methods and systems of the invention, this process is initiated by first placing the bale, or other suitable unit of tobacco, on a scale, such as described above, for example. Next, the grower identification (ID) and farm identification (ID) is scanned, or in some other suitable manner input, into their proper fields by a human user. The weight may be automatically captured, i.e., automatically entered into the unit weight field 410. Alternatively, if using a manual input scale, the user may input the scale into the weight field 410. In accordance with one embodiment of the methods and systems of the invention, if using an automated scale, a weight recapture button 412 may be used to weigh the bale again. This button 412 might be used if there was a concern that the first weight taken was inaccurate.

Then, a user of the user interface 400 may input the USDA grade and the customer grade. This input of the USDA grade and the customer grade may be performed by selecting the respective grades from drop down lists 420, or alternatively, by performing a suitable scanning operation by which to input the grades. Any further information may be entered into the comments field 430 as is desired. In order to complete the process of receiving a unit of tobacco, such that the unit is entered into the database, a user may select the “Print Current Unit Grade Labels” in accordance with this embodiment of the methods and systems of the invention. In order to clear out all information on the screen without saving, a Reset Selection 440 may be selected.

In accordance with the embodiment of the methods and systems of the invention as shown in FIG. 8, a user may enter a previous barcode number for a particular unit in the barcode field 450. Further, a label may be reprinted for that particular unit using a “reprint previous unit grade label” button 460. This allows a user to print a previously processed barcode numbered unit.

FIG. 6 is a flow chart showing in further detail the perform operations to documents and reports receipt of units step 280 of FIG. 4. As shown in FIG. 6, after step 280, the process passes to step 282. In step 282, the grower completes the receiving process. For example, the receiving process may include the grower observing the work of the USDA grader and the company grader. After the grower completes the receiving process, the grower may then proceed to an administrative station 25, as shown in FIG. 1, for generation of the sale bill as well as to receive payment for the units of tobacco that have been delivered. It should be appreciated that such payment may include a base price as well as additional incentives. For example, the additional incentives may be based on the quality of the tobacco or the particular time of year at which the tobacco was delivered to the agent 20, for example. It should be appreciated that the transfer of funds to the grower, equivalent to a determined purchase price, may be performed within minutes of the arrival of units of tobacco at the warehouse or receiving station. After step 282, the process passes to step 284.

In step 284, the administrative station 25, as shown in FIG. 1, transmits end of day purchases to the entity processing system 32. That is, step 284, in accordance with this illustrative embodiment of the system and method of the invention, occurs at the end of each day. It should of course be appreciated that a substantial number of transactions between the agent 20 and various growers 10 will have occurred in any given day. After step 284, the process passes to step 286.

In step 286, the entity receives and processes the purchase information, as well as any other information as is desired, from the agent 20. This processing may be performed at a central operations location. Illustratively, as shown in FIG. 1, such central operations may include an entity processing system connected to a server 34 in the entity 30.

After step 286, the process passes to step 288. In step 288, the process returns to step 290, as shown in FIG. 4.

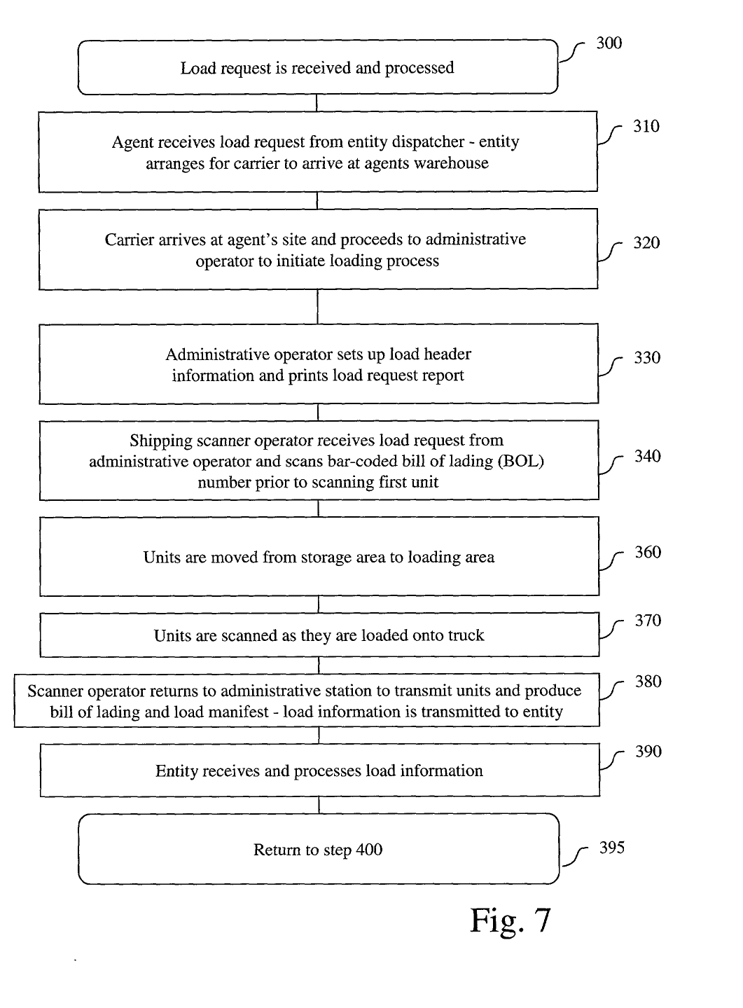

FIG. 7 is a flow chart showing in further detail the load request is received and processed step 300 of FIG. 2. After step 300, as shown in FIG. 7, the process passes to step 310. In step 310, the agent 20 receives a load request from the dispatcher 36 of the entity 30, as shown in FIG. 1. Further, the dispatcher 36 arranges for a carrier to arrive at the agent's warehouse 28, in accordance with one illustrative embodiment of the system and method of the invention. The process then passes to step 320. In step 320, the carrier arrives at the agent's warehouse and proceeds to the administrative operator, for example, to initiate the loading process. Then, the process passes to step 330. In step 330, the administrative operator 26, with reference to FIG. 1, sets up the load header information and prints a load request report. It should be appreciated that such load header information and load request report may be generated based on any of a wide variety of information including information received from the entity processing system 32. After step 330, the process passes to step 340. In step 340, a shipping scanner operator 27, receives the load request from the administrative operator and scans a bar-coded bill of lading (BOL) number prior to scanning the first unit. That is, the BOL number is provided on the load request report. Accordingly, an association is made between the particular load request and the particular units that will be utilized to satisfy that load request. Then, the process passes to step 360. In step 360, the units are moved from a storage area to a suitable loading area, such as the warehouse 28 shown in FIG. 1. Alternatively, the units might be moved from the inventory 24 to the warehouse 28. It should be appreciated, any of the wide variety storage arrangements might be utilized as is desired.

After step 360, the process passes to step 370. In step 370, the units of tobacco are scanned as such units are loaded onto the carriers truck. After step 370, the process passes to step 380. In step 380, the scanner operator 27 returns to the administrative station 25 in order to interface with the administrative station 25 to communicate the particular units used to satisfy the load request. It should be appreciated that this might be performed utilizing a variety of techniques.

For example, the scanner operator 27 might have a portable scanner device which is used by the scanner operator 27 to scan the units of tobacco as they are loaded up on the truck. Thereafter, the scanner operator 27 may place such portable scanner in communication with the administrative station 25 in order to upload the unit data to the administrative station 25.

Further, the scanner operator 27 produces the bill of lading and load manifest. These documents may then be provided to the carrier. Further, the load information is transmitted from the administrative station 25 to the entity processing system 32 utilizing the Internet 40. After step 380, the process passes to step 390. In step 390, the entity 30 receives and processes the load information. Accordingly, the system and method of the invention allow the entity 30 to monitor the activities of the agent 20 in substantial detail. After step 390 is shown in FIG. 7, the process passes to step 395. In step 395, the process returns to step 400 as shown in FIG. 2.

As described above, the dispatcher 36 arranges for a carrier to pick up a desired load of tobacco from the agent 20. Illustratively, the dispatcher 36 might be arranging for the tobacco units to be transported to one of the geographical locations of the entity 30.

Hereinafter, further features of the system and method of the invention, will be described. It should be appreciated that the system and method of the invention as described above allows a unit of tobacco, such as a bale, to be tracked through the entire process. That is, the unit of tobacco may be tracked from an individual farmer to the agent 20 and thereafter to, or under the control of, the entity 30.

Accordingly, the transactions dealing with the tobacco may be closely monitored by the entity 30. This monitoring provides various capabilities. For example, the system and method of the invention provide the entity 30 with the ability to control quota. For example, growers may be issued a marketing card which asserts how much tobacco a grower may sell in a given season. If there is an amount of tobacco sold over that limit, the grower may incur a penalty. That penalty might be paid by the grower or by the purchaser, i.e. the entity 30. However, the system and method of the invention allow the entity 30 to keep track of the amount of the tobacco sold by each farmer. That is, the entity processing system 32 may monitor the pounds of tobacco obtained from each grower. The monitoring may be performed the day before sales begin or the tobacco obtained from the particular grower, or alternatively, the monitoring may be performed on a continued basis as the tobacco units are received from the particular grower.

As tobacco units continue to be received by a particular grower, the entity processing system 32, by obtaining information from the agent 20, essentially counts down any remaining units that may be obtained from a particular grower without incurring a penalty. Once the countdown is complete, that grower is then disallowed from providing any more tobacco. Further, it should be appreciated that the entity processing system 32 may monitor a variety of activities such as common sales and auctions, for example.

It should be appreciated that the entity processing system 32 and the agent processing system 21 may exchange data using any of a wide variety of techniques. Accordingly, such transfer of data may utilize a particular file transfer protocol (FTP). The file transfer protocol is utilized to transfer files over the Internet, i.e., a TCP/IP network. In particular, the file transfer protocol may provide a measure of the data integrity. The data is particularly important with respect to some parameters such as the fee that the entity 30 pays to the agent 20 or the grade of tobacco.

To explain further, various types of information may not be allowed to be maintained by the agent 20, but rather directly communicated to the entity 30 at the end of every business day, for example. That is, for example, once the agent 20 enters particular data into the agent processing system 21, for example, the agent is not provided with an interface by which to access such data, or alternatively, the agent has “read only” access to the data. Also, the agent may not be able to access or have knowledge of various techniques for processing the data.

In accordance with one embodiment of the methods and systems of the invention, only the entity 30 is provided with the capability to observe certain data. Accordingly, in one embodiment of the system and method of the invention, the data formats are provided by the entity 30. These data formats are placed on the agent server 22, but may not be accessible by the agent 20.

When the agent performs its normal end of the day process for transmitting data to the entity 30, the agent also looks on the entity server 34 for information to go to the agent 20. If there is any information on the entity server 34, then that information is communicated to the agent server 22. For example, files may be picked up from the entity server 34 and those files may then be utilized to populate the agent processing system 21 with new data received from the entity 30. Illustratively, this new data may be utilized by the agent 20 to process the units received on the next business day. That is, data is sent from the entity 30 to the agent 20 for control of activities of the agent 20. Further, the entity 30 and the agent 20 may communicate with each other in order to back-up data as is desired.

As noted above, it should be appreciated that multiple growers may share a single farm or farms. For example, there may be ten growers, i.e., ten individuals, and there may be five farms which are controlled by those ten growers. In other words, the ten growers form what might be characterized as a cooperative arrangement. The entity processing system 32 and the agent processing system 21 may possess various data and programming capabilities to efficiently address such a cooperative arrangement. Further, it should be noted that other arrangements might be closely monitored utilizing the processing and communication capabilities of the entity 30 and the agent 20. For example, processing may quickly and easily occur in a situation where a particular grower is leasing land from the owner of that land, and in which the particular grower is provided with a portion of the purchase price and the owner of the land is provided with a complimentary portion of the purchase price.

It should be appreciated that the system and method of the invention provide substantial capabilities relating to inventory of tobacco units. For example, such inventory might be performed for units physically located at an agent 20 location or an entity 30 location. As noted above, the labels on the units of tobacco may be scanned prior to loading on a carrier's truck. This scanning in particular allows the close monitoring of inventory of the agent 20.

It should be further appreciated that a wide variety of data processing applications might be utilized in the entity processing system 32 and the agent processing system 21. In particular, there may provided a shipping application, and administrative application and a receiving application. It should be appreciated that such applications may be different, or used in a different manner, between the entity processing system side and the agent processing system side. The shipping application may be provided to control various processing and data manipulation relating to shipping units of tobacco. Further, the receiving application may control various processing and data manipulation relating to the agent 20 receiving units of tobacco from a grower 10. Also, an administrative application might be utilized. The administrative application may control a wide variety of operations performed in the agent 20, the data from which is forwarded to the entity 30. That is, the administrative application may control sale, bill processing or payment and check generation, for example.

As described above, the units of tobacco may be shipped from the agent 20 at the request of the entity 30. A scanning process is utilized in such shipping as noted above. In accordance with one embodiment of the system and method of the invention, such shipping is controlled by the shipping application, i.e., a software application operating on the agent processing system 21. It should be appreciated that the shipping process performed by the agent 20 does not involve any keying of information in accordance with one embodiment of the methods and systems of the invention. Rather, the units of tobacco allotted for a requested load are each scanned. As a result of the scanning, the assimilated data is then associated with the load requests. This information might then be used to generate a report which is prepared at or communicated to the entity 30. Accordingly, the absence of any required keying in the shipment from the agent 20 allows the agent 20 to react very quickly to requested orders. Such capability is especially helpful when dealing with very large orders.

Hereinafter, further aspects of sale bill creation will be described in accordance with one embodiment of the system and method of the invention. As described above, upon the receipt of units of tobacco and processing of those units of tobacco, a sale bill creation occurs in which various documents recording the receipt and particulars of the sale are generated. In accordance with once aspect of this sale bill creation, a determination is made of what units should be paid for. That is, it should be appreciated that some units may not be paid for since they are rejected units. Such rejected units might be a result of poor quality. The system and method of the invention allows continued tracking of those rejected units. Further, the invention allows such rejection units to be disposed of in some suitable or predetermined manner.

Further, the system and method of the invention, in accordance with one embodiment, may provide a multiple pay structure. For example, a particular grower may split his check that he receives as a result of delivery of tobacco units between 2 persons. For example, 50% of the monies may go to the grower himself and 50% of the monies may go to another individual. Various other pay situations may be easily and quickly performed utilizing your processing capabilities of the transaction system 1 of the invention.

The systems and methods of the invention allow the entity 30 to closely monitor a wide variety of parameters including various “numbers” related to the receipt and shipping of units of tobacco. For example, the numbers observed by the agent 20 may be compared and matched to the numbers observed by the entity 30. For example, an application may be utilized by the agent 20 to confirm that all is in order relating to receipt or shipment relating to an order of tobacco. For example, using a suitable user interface, the administrative operator 26 may observe a visual on-stream notification relating to the total dollars of a shipment, the total pounds of a shipment, and whether all government-required documents are present and have been verified, such as by a matching number scheme.

In accordance with one embodiment of the system and method of the invention, the agent 20 may utilize a unit label reproduction technique. To explain, it should be appreciated that labels may be damaged as a result of physical handling of the units of tobacco by the agent 20. Accordingly, if a tag for some reason is damaged in inventory, for example, that damaged tag may be replaced. For example, if the unit is in the process of being loaded onto a truck for shipment, the shipping scanner operator 27 may scan the second tag. Through a suitable request, the shipping scanner operator 27 will then be provided with a printed replacement tag.

It should be appreciated that two grades may be utilized in receiving and shipping units of tobacco. These two grades include a company grade and a control price grade. The control grade is controlled by authorities and cannot be changed subsequent to the units of tobacco being received from a grower. In contrast, the company grade is internal to operations of the entity 30 and the agent 20, and is for internal informational purposes.

It should be appreciated that situations might change as a unit of tobacco moves through the receiving and shipping process of the invention. As a result of such changed situation, it may be desired to change the company grade of a particular unit or units of tobacco. The transaction system in accordance with embodiments of the system and method of the invention allows such a change of company grade to be effected quickly and easily. That is, it should be appreciated that the grade may in fact not be physically present on a label attached to the unit of tobacco. Rather, the company grade of a particular unit of tobacco may be only stored in the databases of the agent processing system 21 and/or the entity processing system 32. Alternatively, the grade made be physically displayed on the unit of tobacco. If the company grade is physically displayed on the unit of tobacco, then the transaction system in accordance with embodiments of the system and method of the invention allow a replacement tag to be easily generated, and printed, reflecting the change of company grade.

In accordance with one embodiment of the methods of the invention, a company grade may be changed prior to the end of day processing, after which two new labels are printed with the new company grades thereon. Alternately, it may be the case that the company grade may be changed after the end of day processing, i.e., after the data from a particular day has been transmitted to the entity 30. In this case, for example, the new company grade may simply be written on the existing tags.

While the foregoing description includes many details and specifications, it is to be understood that these have been included for purposes of explanation only, and are not to be interpreted as limitations of the present invention. Many modifications to the embodiments described above can be made without departing from the spirit and scope of the invention, as is intended to be encompassed by the claims and their legal equivalents.

What is claimed is:

1. A method for enabling a grower to identify a unit of tobacco to facilitate identification of the unit of tobacco through a transaction, the method comprising the steps of:
providing an identification tag that is affixed, by the grower, to the unit of tobacco as part of a processing routine that occurs prior to presenting the unit of tobacco as part of the transaction; and
presenting the unit of tobacco to an agent, the agent scanning the identification tag.

2. The method of claim 1, wherein the transaction is a purchase of the unit of tobacco.

3. The method of claim 1, wherein the processing routine that occurs prior to presenting the unit of tobacco as part of the transaction further includes preparing the unit of tobacco for transportation to a warehouse.

4. The method of claim 1, wherein the identification tag is a preprinted tag.

5. The method of claim 4, wherein the preprinted tag further comprises an optically readable code, the optically readable code representing:
a grower identifier; and
a Farm Service Agency (FSA) number.

6. A method for an agent, working under a controlling entity, to warehouse units of tobacco in connection with a transaction involving at least one unit of tobacco, the method comprising the steps of:
optically reading an identification tag affixed to the unit of tobacco, wherein the identification tag comprises at least one of a grower identifier and a farm identifier;
determining a weight for the unit of tobacco;
determining a grade for the unit of tobacco;
scanning the grade from a preprinted optical grade label into a processor;
applying a per unit of measure price for the unit of tobacco based, at least in part, upon the grade of the unit of tobacco; and
generating a label that is to be affixed to the unit of tobacco, the label including a grade indicator and a unique identifier for the unit of the tobacco.

7. The method of claim 6, further including the steps of:
the agent receiving a load request from the entity, the processor generating a bill of lading number as a result of the load request; and
inputting the bill of lading number prior to scanning a first unit of tobacco that will used to satisfy the load request.

8. The method of claim 7, wherein the inputting the bill of lading number is performed by scanning operation.

9. The method of claim 6, wherein the grade indicator includes a control grade and a company grade.

10. The method of claim 9, further including the steps of:
changing the company grade after the purchase of a unit of tobacco; and
reprinting a label to reflect the changed company grade.

11. A method of providing an incentive to a grower of tobacco based on the quality of the tobacco, the method comprising:
providing a price per grade for a unit of tobacco;
logging, by an agent, each unit of tobacco purchased from a grower;
logging, by an agent, the grade of each unit of tobacco purchased; and
assigning a base price to the unit and an incentive price to the unit as two separate elements; and
outputting data to an entity relating to the logging each unit of tobacco purchased from a grower and the logging the grade of each unit of tobacco purchased, the entity monitoring activities of the agent.

12. A method for purchasing a unit of tobacco from at least one grower, wherein the at least one grower transports the unit of tobacco to a warehouse, which is controlled by an agent working under an entity, to enable a sale of the unit of tobacco, the method comprising:
recording, into a processor, an identifier for the unit of tobacco upon arrival at the warehouse;
recording a weight for the unit of tobacco into the processor;
recording a grade for the unit of tobacco into the processor; and
determining a purchase price for the unit of tobacco based, at least in part, upon the recorded weight and the recorded grade.

13. The method of claim 12, wherein the determining the purchase price for the unit of tobacco based, at least in part, upon the recorded weight and the recorded grade step is performed by accessing a look-up-table.

14. The method of claim 12, further including the step of using the processor to initiate a transfer of funds to the grower, equivalent to the determined purchase price, wherein the transfer of funds is initiated within minutes of the arrival of the unit of tobacco at the warehouse.

15. The method of claim 12, further including the steps of:
monitoring an amount of tobacco purchased from the grower over a period of time; and
disallowing any further purchase of tobacco from the grower once a quota of the grower is attained.

16. The method of claim 12, further including the steps of:
maintaining of an agent server by the agent; and
maintaining of an entity server by the entity, the entity server in communication with the agent server, wherein the agent server downloads and uploads data files from the entity server relating to the purchase of tobacco.

17. The method of claim 12, wherein the at least one grower includes a plurality of growers, the plurality of growers sharing a farm, the method further including processing purchases of tobacco from each grower from a particular farm taking into account that such growers are from the same farm.

18. The method of claim 17, wherein the step of processing purchases of tobacco from each grower from a particular farm taking into account that such growers are from the same farm includes:
paying a particular grower a percentage of the purchase price; and
paying an owner of the farm a percentage of the purchase price.

19. The method of claim 12, further including the steps of:
the processor creating a sale bill based on the purchase price; and
the processor creating a payment document based on the purchase price.

20. The method of claim 19, wherein the payment document is a check.

21. A method for a tobacco purchaser to track one or more agent's purchases of one or more units of tobacco, the method comprising:
requesting sales data from one or more agent's processor devices;
receiving sales data from the one or more agent's processor devices;
updating a file of the tobacco purchaser comprising sales data relating to purchases of one or more units of tobacco, wherein the steps of requesting sales data and receiving sales data are conducted over a distributed processor network.

22. The method of claim 21, wherein the distributed processor network is the Internet.

23. A system for purchasing a unit of tobacco from at least one grower, wherein the at least one grower transports the unit of tobacco to a warehouse, which is controlled by an agent working under an entity, to enable a sale of the unit of tobacco, the system comprising:
an agent including a warehouse, an agent processing system and an agent server, the agent processing system recording an identifier for the unit of tobacco upon arrival at the warehouse, a weight for the unit of tobacco, and a grade for the unit of tobacco, the agent processing system determining a purchase price for the unit of tobacco based, at least in part, upon the recorded weight and the recorded grade;
an entity that controls and monitors purchases of tobacco of the agent, the entity including an entity processing system and an entity server;
wherein the agent server obtains data relating to the purchase of tobacco units from the agent processing system, the agent server communicating the data to the entity server, and the entity server outputting the data to the entity processing system for processing.
